(19) United States
(12) Patent Application Publication
(10) Pub. No.: US 2024/0158315 A1
(43) Pub. Date: May 16, 2024

(54) WATER SUBMERSIBLE CONTROLLED RELEASE FERTILIZER PARTICLE

(71) Applicant: Huntsman International LLC, The Woodlands, TX (US)

(72) Inventors: Amit Kumar SHARMA, Auburn Hills, MI (US); Justin McLean FOGARTY, Auburn Hills, MI (US); Daniel Paul HEBERER, Auburn Hills, MI (US); Jinhuang WU, Auburn Hills, MI (US)

(21) Appl. No.: 18/280,704

(22) PCT Filed: Mar. 9, 2022
(86) PCT No.: PCT/US2022/019524

§ 371 Date: Sep. 7, 2023

Related U.S. Application Data
(60) Provisional application No. 63/160,108, filed on Mar. 12, 2021.

(51) Int. Cl. C05G 3/40; C05C 9/00; C05G 5/30

(52) U.S. Cl. CPC C05G 3/44; C05C 9/00; C05G 5/37; C05G 5/38

(57) ABSTRACT

A water submersible controlled release fertilizer particle comprising: (i) a fertilizer core material; (ii) a polyurethane coating layer encapsulates the fertilizer core material; and (iii) a hydrophilic outer layer encapsulates the polyurethane coating layer wherein the hydrophilic outer layer dissolves when subjected to water.

### BACKGROUND

### Field

The present disclosure relates generally to a controlled release fertilizer particle. Specifically, the present disclosure is directed to a water submersible controlled release fertilizer particle.

### Background

Fertilizers have been used in the agricultural industry to aid in the supply of nutrients to plant's growing media. In recent years, the industry has focused on developing techniques to supply nutrients gradually to the soil. It has been recognized now that polymer encapsulated fertilizer granules provide better control over the nutrients' release rate over a given time.

Unfortunately, the performance of some polymer encapsulated fertilizer granules used with semiaquatic crops (e.g., rice or taro) is lacking. In an aquatic environment, polymer encapsulated fertilizer granules tend to consolidate or agglomerate in certain areas rather than uniformly distribute across a wide area. This consolidation characteristic is caused primarily by the hydrophobic nature of the coatings used on the polymer encapsulated fertilizer granules. While certain surfactants may be added to aid in the distribution of the granules in a water environment, the polymer encapsulated fertilizer granules that utilize such surfactants exhibit poor timed release characteristics when compared to polymer encapsulated fertilizer granules that do not use such surfactants. Therefore, there remains a need to develop a polymer encapsulated fertilizer granule that can remain submerged in an aqueous environment while also exhibiting controlled release of nutrients over a certain time to improve grain yield and reduce nutrient loss.

### BRIEF DESCRIPTION OF THE DRAWINGS

FIG. 1 is an overview of a coating application process.

FIG. 2 is a graphic depiction of a result of a test conducted on a plurality of water submersible controlled release fertilizer particles versus a Non-coated CRF.

FIG. 3 is a graph depicting the release of urea from the water submersible controlled release fertilizer particles over a given period of time versus a Non-coated CRF.

### DETAILED DESCRIPTION

As used herein, unless otherwise expressly specified, all numbers such as those expressing values, ranges, amounts or percentages may be read as if prefaced by the word “about”, even if the term does not expressly appear. Plural encompasses singular and vice versa.

As used herein, “plurality” means two or more while the term “number” means one or an integer greater than one.

As used herein, “includes” and like terms means “including without limitation.”

When referring to any numerical range of values, such ranges are understood to include each and every number and/or fraction between the stated range minimum and maximum. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “molecular weight” means weight average molecular weight (M_{w}) as determined by Gel Permeation Chromatography.

Unless otherwise stated herein, reference to any compounds shall also include any isomers (e.g., stereoisomers) of such compounds.

### Water Submersible Controlled Release Fertilizer Particle

The present disclosure is directed to a water submersible controlled release fertilizer particle that can remain submerged in an aqueous environment, such as water, while also exhibiting controlled release of nutrients over a certain time to improve grain yield and reduce nutrient loss. Accordingly, the present disclosure is directed to a water submersible controlled release fertilizer particle comprising: (i) a fertilizer core material; (ii) a polyurethane coating layer encapsulates the fertilizer core material; and (iii) a hydrophilic outer layer encapsulates the polyurethane coating layer wherein the hydrophilic outer layer dissolves when subjected to water for a period ranging from 0 to 24 hours (e.g., 0 to 5 hours or 0 to 10 hours).

In an aqueous environment, such as a rice a rice or taro paddy field, the water submersible controlled fertilizer particle of the present disclosure will sink to the bottom of the paddy field (i.e., does not float) due to the near instant wet-out nature of the hydrophilic coating coupled with the weight of the water submersible controlled release fertilizer particle. While at the bottom of the paddy field, the water submersible controlled fertilizer particle may also stick to the underlying soil thereby anchoring the fertilizer in place. The water submersible controlled fertilizer particle can then provide a linear release rate of nutrients to the growing semiaquatic crops (e.g., rice or taro) for a period ranging from 30 days to 60 days.

In certain embodiments, the water submersible controlled release fertilizer particle does not contain a surfactant (e.g., a silicone based surfactant) in any of its coating layers.

### Component (i): Fertilizer Core Material

Any fertilizer particle that is known in the agricultural industry can be used as the fertilizer core material of the water submersible controlled fertilizer particle. The fertilizer particle comprises a nitrogen fertilizer material comprising at least 5% (e.g., ≤10%, ≤20%, or ≤30%) by weight nitrogen based on the total weight of the fertilizer particle. The fertilizer particle can also comprise one or more of the following compounds: urea, ammonium, potassium, calcium, phosphorus, sulphur, or salts thereof (e.g., sulfate, ammonium sulphate, or ammonium nitrate).

The inorganic material used can be urea, ammonium, calcium silicate, potassium, calcium, phosphorus, sulphur, or any salts thereof salts (e.g., sulfate, ammonium sulphate, or ammonium nitrate).

In certain embodiments, the fertilizer core material comprises at least 50% by weight urea and at least 40% by weight nitrogen based on the total weight of the fertilizer core material. In other embodiments, the ammonium salts are present in an amount of less than 10% (e.g., ≥5%) by weight based on the total weight of the fertilizer particle.

The fertilizer particles have a particle size ranging from 0.10 to 20 mm (e.g., 0.5 to 15 mm or 1.5 to 5 mm). The particles have a weight average particle size in this range or for instance wherein ≤90% by weight of the particles have a particle size in this range, wherein the size of a particle refers for example to the minimum size. The particles can be granulated or prilled fertilizers, or pelletized, pas tilled, or compacted fertilizer.

### Component (ii): Polyurethane Coating Layer

A polyurethane coating layer is applied onto the fertilizer core material thereby substantially encapsulating the fertilizer core material. The polyurethane coating layer provides for the controlled release of fertilizer to the crop via hydrolysis, biodegradation, limited solubility, or by a combination thereof. The polyurethane coating layer may be water-impermeable or semipermeable. Ideally, the polyurethane coating layer protects the fertilizer from soil processes until the fertilizer is released.

In some embodiments, polyurethane coating layer is semipermeable (e.g., permeable for water but impermeable for the fertilizer such as urea) and upon application on land, water enters through the coating due to osmosis, causing swelling of the fertilizer material core. This can result in the coating cracking open and/or movement of fertilizer material through pores in the coating layer. In this way, sustained and/or delayed release of the coating material can be achieved.

The polyurethane coating layer is at least 0.0010% (e.g., 0.10 to 10%, 0.2 to 5%, 0.3 to 3.0%, 0.3 to 1.5%, or 0.5 to 1.2%) by weight based on the total weight of Components (i) and (ii).

In certain embodiments, the dry film coating thickness of the polyurethane coating layer ranges from 1.0 micron to 50 microns (e.g., 1 micron to 40 microns, 1 micron to 30 microns, 1 micron to 20 microns). However, other thicknesses are also possible depending on the desired timed-release properties that is desired by a formulator.

The polyurethane coating layer is the reaction product of a reactive composition comprising: (a) an isocyanate compound and (b) an isocyanate reactive compound.

### Component (a): Isocyanate Compound

Suitable polyisocyanate compounds that may be used as a reactive ingredient to form the polyurethane coating layer include aliphatic, araliphatic, and/or aromatic polyisocyanates. The isocyanate compounds typically have the structure R—(NCO)ₓ where x is at least 2 and R comprises an aromatic, aliphatic, or combined aromatic/aliphatic group. Non-limiting examples of suitable polyisocyanates include diphenylmethane diisocyanate (“MDI”) type isocyanates (e.g., 2,4′-, 2,2′-, 4,4′-MDI or mixtures thereof), mixtures of MDI and oligomers thereof (e.g., polymeric MDI or “crude” MDI), and the reaction products of polyisocyanates with components containing isocyanate-reactive hydrogen atoms (e.g., polymeric polyisocyanates or prepolymers). Accordingly, suitable isocyante compounds that may be used include SUPRASEC® DNR isocyanate, SUPRASEC® 2185 isocyanate, RUBINATE® M isocyanate, and RUBINATE® 1840 isocyanate, or combinations thereof. As used herein, SUPRASEC® and RUBINATE® isocyanates are all available from Huntsman Petrochemical LLC. which are all available from Huntsman International LLC.

Other examples of suitable isocyanate compounds also include tolylene diisocyanate (“TDI”) (e.g., 2,4 TDI, 2,6 TDI, or combinations thereof), hexamethylene diisocyanate (“HMDI” or “HDI”), isophorone diisocyanate (“IPDI”), butylene diisocyanate, trimethylhexamethylene diisocyanate, di(isocyanatocyclohexyl)methane (e.g. 4,4′-diisocyanatodicyclohexylmethane), isocyanatomethyl-1,8-octane diisocyanate, tetramethylxylene diisocyanate (“TMXDI”), 1,5-naphtalenediisocyanate (“NDI”), p-phenylenediisocyanate (“PPDI”), 1,4-cyclohexanediisocyanate (“CDI”), tolidine diisocyanate (“TODI”), or combinations thereof. Modified polyisocyanates containing isocyanurate, carbodiimide or uretonimine groups may also be employed as Component (i).

Blocked polyisocyanates can also be used as Component (a) provided that the reaction product has a deblocking temperature below the temperature at which Component (a) will be reacted with Component (b). Suitable blocked polyisocyanates can include the reaction product of: (x) a phenol or an oxime compound and a polyisocyanate, or (y) a polyisocyanate with an acid compound such as benzyl chloride, hydrochloric acid, thionyl chloride or combinations. In certain embodiments, the polyisocyanate may be blocked with the aforementioned compounds prior to introduction into the reactive ingredients/components used to in the composition disclosed herein.

Mixtures of isocyanates, for example, a mixture of TDI isomers (e.g., mixtures of 2,4- and 2,6-TDI isomers) or mixtures of di- and higher polyisocyanates produced by phosgenation of aniline/formaldehyde condensates may also be used as Component (i).

In some embodiments, the isocyanate compound is liquid at room temperature. A mixture of isocyanate compounds may be produced in accordance with any technique known in the art. The isomer content of the diphenyl-methane diisocyanate may be brought within the required ranges, if necessary, by techniques that are well known in the art. For example, one technique for changing isomer content is to add monomeric MDI (e.g., 2,4-MDI) to a mixture of MDI containing an amount of polymeric MDI (e.g., MDI comprising 30% to 80% w/w 4,4′-MDI and the remainder of the MDI comprising MDI oligomers and MDI homologues) that is higher than desired.

Component (a) can comprise 30% to 65% (e.g., 33% to 62% or 35% to 60%) by weight of the reactive composition (i.e., total weight of components (a) and (b)).

### Component (b): Isocyanate Reactive Compound

Any of the known organic compounds containing at least two isocyanate reactive moieties per molecule may be employed as isocyanate reactive compound used as a reactive ingredient to form the polyurethane coating layer. Polyol compounds or mixtures thereof that are liquid at 25° C., have a molecular weight ranging from 60 to 10,000 (e.g., 300 to 10,000 or less than 5,000), a nominal hydroxyl functionality of at least 2, and a hydroxyl equivalent weight of 30 to 2000 (e.g., 30 to 1,500 or 30 to 800) can be used as Component (ii).

Examples of suitable polyols that may be used as Component (b) include polyether polyols such as those made by addition of alkylene oxides to initiators, which containing from 2 to 8 active hydrogen atoms per molecule. In some embodiments, the aforementioned initiators include glycols, glycerol, trimethylolpropane, triethanolamine, pentaerythritol, sorbitol, sucrose, ethylenediamine, ethanolamine, diethanolamine, aniline, toluenediamines (e.g., 2,4 and 2,6 toluenediamines), polymethylene polyphenylene polyamines, N-alkylphenylene-diamines, o-chloro-aniline, p-aminoaniline, diaminonaphthalene, or combinations thereof. Suitable alkylene oxides that may be used to form the polyether polyols include ethylene oxide, propylene oxide, and butylene oxide, or combinations thereof.

Other suitable polyol compounds that may be used as Component (ii) include Mannich polyols having a nominal hydroxyl functionality of at least 2, and having at least one secondary or tertiary amine nitrogen atom per molecule. In some embodiments, Mannich polyols are the condensates of an aromatic compound, an aldehyde, and an alkanol amine. For example, a Mannich condensate may be produced by the condensation of either or both of phenol and an alkylphenol with formaldehyde and one or more of monoethanolamine, diethanolamine, and diisopronolamine. In particular, embodiments, the Mannich condensates are those of phenol or nonylphenol with formaldehyde and diethanolamine. The Mannich condensates of the present invention may be made by any known process. In some embodiments, the Mannich condensates serve as initiators for alkoxylation. Any alkylene oxide (e.g., those alkylene oxides mentioned above) may be used for alkoxylating one or more Mannich condensates. When polymerization is completed, the Mannich polyol comprises primary hydroxyl groups and/or secondary hydroxyl groups bound to aliphatic carbon atoms.

In certain embodiments, the polyols that are used are polyether polyols that comprise propylene oxide (“PO”), ethylene oxide (“EO”), or a combination of PO and EO groups or moieties in the polymeric structure of the polyols. These PO and EO units may be arranged randomly or in block sections throughout the polymeric structure. In certain embodiments, the EO content of the polyol ranges from 0 to 100% by weight based on the total weight of the polyol (e.g., 50% to 100% by weight). In some embodiments, the PO content of the polyol ranges from 100 to 0% by weight based on the total weight of the polyol (e.g., 100% to 50% by weight). Accordingly, in some embodiments, the EO content of a polyol can range from 99% to 33% by weight of the polyol while the PO content ranges from 1% to 66% by weight of the polyol. Moreover, in some embodiments, the EO and/or PO units can either be located terminally on the polymeric structure of the polyol or within the interior sections of the polymeric backbone structure of the polyol. Suitable polyether polyols include poly(oxyethylene oxypropylene) diols and triols obtained by the sequential addition of propylene and ethylene oxides to di- or trifunctional initiators that are known in the art. In certain embodiments, Component (b) comprises the aforementioned diols or triols or, alternatively, Component (b) can comprise a mixture of these diols and triols.

The aforementioned polyether polyols also include the reaction products obtained by the polymerization of ethylene oxide with another cyclic oxide (e.g., propylene oxide) in the presence of polyfunctional initiators such as water and low molecular weight polyols. Suitable low molecular weight polyols include ethylene glycol, propylene glycol, diethylene glycol, dipropylene glycol, cyclohexane dimethanol, resorcinol, bisphenol A, glycerol, trimethylolopropane, 1,2,6-hexantriol, pentaerythritol, or combinations thereof.

Polyester polyols that can be used as Component (b) include polyesters having a linear polymeric structure and a number average molecular weight (Mn) ranging from about 500 to about 10,000 (e.g., preferably from about 700 to about 5,000 or 700 to about 4,000) and an acid number generally less than 1.3 (e.g., less than 0.8). The molecular weight is determined by assay of the terminal functional groups and is related to the number average molecular weight. The polyester polymers can be produced using techniques known in the art such as: (1) an esterification reaction of one or more glycols with one or more dicarboxylic acids or anhydrides; or (2) a transesterification reaction (i.e. the reaction of one or more glycols with esters of dicarboxylic acids). Mole ratios generally in excess of more than one mole of glycol to acid are preferred so as to obtain linear polymeric chains having terminal hydroxyl groups. Suitable polyester polyols also include various lactones that are typically made from caprolactone and a bifunctional initiator such as diethylene glycol. The dicarboxylic acids of the desired polyester can be aliphatic, cycloaliphatic, aromatic, or combinations thereof. Suitable dicarboxylic acids which can be used alone or in mixtures generally have a total of from 4 to 15 carbon atoms include succinic, glutaric, adipic, pimelic, suberic, azelaic, sebacic, dodecanedioic, isophthalic, terephthalic, cyclohexane dicarboxylic, or combinations thereof. Anhydrides of the aforementioned dicarboxylic acids (e.g., phthalic anhydride, tetrahydrophthalic anhydride, or combinations thereof) can also be used. In some embodiments, adipic acid is the preferred acid. The glycols used to form suitable polyester polyols can include aliphatic and aromatic glycols having a total of from 2 to 12 carbon atoms. Examples of such glycols include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, or combinations thereof.

Additional examples of suitable polyols include hydroxyl-terminated polythioethers, polyamides, polyesteramides, polycarbonates, polyacetals, polyolefins, polysiloxanes, and simple glycols such as ethylene glycol, butanediols, diethylene glycol, triethylene glycol, the propylene glycols, dipropylene glycol, tripropylene glycol, and mixtures thereof.

The active hydrogen-containing material may contain other isocyanate reactive material such as, without limitation, polyamines and polythiols. Suitable polyamines include primary and secondary amine-terminated polyethers, aromatic diamines such as diethyltoluene diamine and the like, aromatic polyamines, and combinations thereof.

Component (b) can comprise 20% to 50% (e.g., 23% to 47% or 25% to 45%) by weight of the reactive composition.

### Component (iii): Hydrophilic Outer Layer

A hydrophilic outer layer is applied onto the polyurethane coating layer thereby substantially encapsulating the polyurethane coating layer. The hydrophilic outer layer can be described as a “temporary” coating layer that is used to instantly wet-out and absorb water thereby aiding in the submerging characteristic of the water submersible controlled release fertilizer particle. Once in a aqueous environment, such as water, the hydrophilic outer layer will dissolve over a period ranging from 0 to 24 hours (e.g., 0 to 5 hours or 0 to 10 hours). Once a portion of the hydrophilic outer layer is dissolved, the water submersible controlled release fertilizer particle will begin to release its nutrients over a specified time period.

The hydrophilic outer layer is comprised of a polyol, such as the polyols described in connection with Component (b) above, and an inorganic material. The inorganic material used can be urea, ammonium, calcium silicate, potassium, calcium, phosphorus, sulphur, or any salts thereof salts (e.g., sulfate, ammonium sulphate, or ammonium nitrate), clays, titanium dioxide, or combinations thereof. The inorganic material is used as an “anti-caking” agent to prevent the water submersible controlled release fertilizer particle from sticking or agglomerating to other water submersible controlled release fertilizer particles. This aids in the uniform distribution of the water submersible controlled release fertilizer particle in the paddy field. Moreover, the hydrophilic outer layer can also be used as a vehicle to deliver nutrients to the crop by using a nutrient element (e.g., sulfur) as the inorganic material. This allows the water submersible controlled release fertilizer particle to not only distribute needed nutrients via Component (i) but also via the hydrophilic outer layer.

The hydrophilic coating layer is at least 0.0010% (e.g., 0.10 to 10%, 0.2 to 5%, 0.3 to 5.0%, 0.5 to 3%, or 1.0 to 2.0%) by weight based on the total weight of Components (i) and (ii).

In certain embodiments, the coating thickness of the hydrophilic outer layer ranges from 1.0 micron to 5 microns (e.g., 1 micron to 3 microns or 2 microns to 3 microns). However, other thicknesses are also possible depending on the desired timed release properties that is desired by a formulator.

### Additional Coating Layers

### Second and Third Polyurethane Coating Layers

In some embodiments, the water submersible controlled release fertilizer particle can comprise additional polyurethane and/or wax layers beyond the ones that were described above. Even in these embodiments, the hydrophilic outer layer will still be the outermost layer of the water submersible controlled release fertilizer particle.

In some embodiments, an additional polyurethane coating layers can be applied onto Component (ii) thereby substantially encapsulating the polyurethane coating layer described above. Any of the components described in connection with Components (a) and (b) above may be used to form the second polyurethane coating layer. In some embodiments, the second polyurethane coating layer is made from the same materials used to form the polyurethane coating layer. In other embodiments, the second polyurethane coating layer is made from materials that are different from the materials used to form the polyurethane coating layer.

A third polyurethane coating layer may be applied onto the second polyurethane coating layer thereby substantially encapsulating the second polyurethane coating layer. Like the second polyurethane coating layer, any of the components described in connection with Components (a) and (b) may be used to form the third polyurethane coating layer. In some embodiments, the third polyurethane coating layer is made from the same materials used to form both the polyurethane coating layer and the second polyurethane coating layer. In other embodiments, the third polyurethane coating layer is made from materials that are different from the materials used to form the polyurethane coating layer or the second polyurethane coating layer.

Each of the second and third polyurethane coating layers is at least 0.0010% (e.g., 0.10 to 10%, 0.2 to 5%, 0.3 to 3.0%, 0.3 to 1.5%, or 0.5 to 1.2%) by weight based on the total weight of Components (i) and (ii).

Similar to the polyurethane coating layer described above, the dry film coating thickness of the additional polyurethane coating layers ranges from 1.0 micron to 50 microns (e.g., 1 micron to 40 microns, 1 micron to 30 microns, 1 micron to 20 microns). However, other thicknesses are also possible depending on the desired timed-release properties that is desired by a formulator.

### Wax Coating Layer

In certain embodiments, a wax coating layer may be applied onto Component (ii) thereby substantially encapsulating Component (ii). In other embodiments, the wax coating layer can be sandwiched between any of Component (ii), the second polyurethane coating, layer, and the third polyurethane coating layer.

The wax material used in the wax coating layer can be any wax such as a paraffin wax, petrolatum wax, polyamide wax, a micro crystalline wax, or an olefin wax (e.g., an alpha-olefin wax), or combinations thereof.

The wax coating layer is at least 0.0010% (e.g., 0.10 to 10%, 0.2 to 5%, 0.3 to 3.0%, 0.3 to 1.5%, or 0.5 to 1.2%) by weight based on the total weight of Components (i) and (ii).

In certain embodiments, the coating thickness of the wax coating layer ranges from 1.0 micron to 50 microns (e.g., 1 micron to 40 microns, 1 micron to 30 microns, 1 micron to 20 microns). However, other thicknesses are also possible depending on the desired timed release properties that is desired by a formulator.

### Application

The various coating layers described herein can be applied using various techniques that are known in the art. For example, the application techniques described in International Patent Publication No. 2020/016672 (which is incorporated herein in its entirety by reference) may be used to apply one or more the coating layers described above.

### Modifications

While specific embodiments of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof. Therefore, any of the features and/or elements which are listed above may be combined with one another in any combination and still be within the breadth of this disclosure.

### EXAMPLES

### Components:

Fertilizer: uncoated urea granules available from having a nitrogen content of 46%.
Filler: Hubersorb 250 Calcium silicate available from Akrochem Corporation.
Isocyanate: SUPRASEC 9700 polymeric MDI available from Huntsman International LLC.
Polyol: RIMLINE SA 97067 polyether polyol available from Huntsman International LLC.
Additive: Additive available from Huntsman International LLC.
Wax: Alpha olefinic wax available from Chevron Phillips Chemical Company LP.

### Example 1: Polyurethane Coated Fertilizer Particle

A polyurethane coated fertilizer particle was made with the following materials:

| Fertilizer amount | 4000 (grams) |
|---|---|
| Final weight of | 4176.67 (grams) |
| coated particles | |
| Coating weight %* | 4.23% |
| Wax weight %* | 0.75 |
| Filler % | 0.0 |
| Number of coating steps | 4 |

*Based on the final weight of the coated particles.

| | | Total | Amount per |
|---|---|---|---|
| | | Charge | Coating Step |
| Material | Weight % | (grams) | (grams) |
| Poyol | 38.31 | 56.19 | 14.05 |
| Isocyanate | 61.69 | 90.48 | 22.62 |
| Wax | 0.75 | 30.00 | 0.0 |
| Filler | 0.0 | 0.0 | 0.0 |

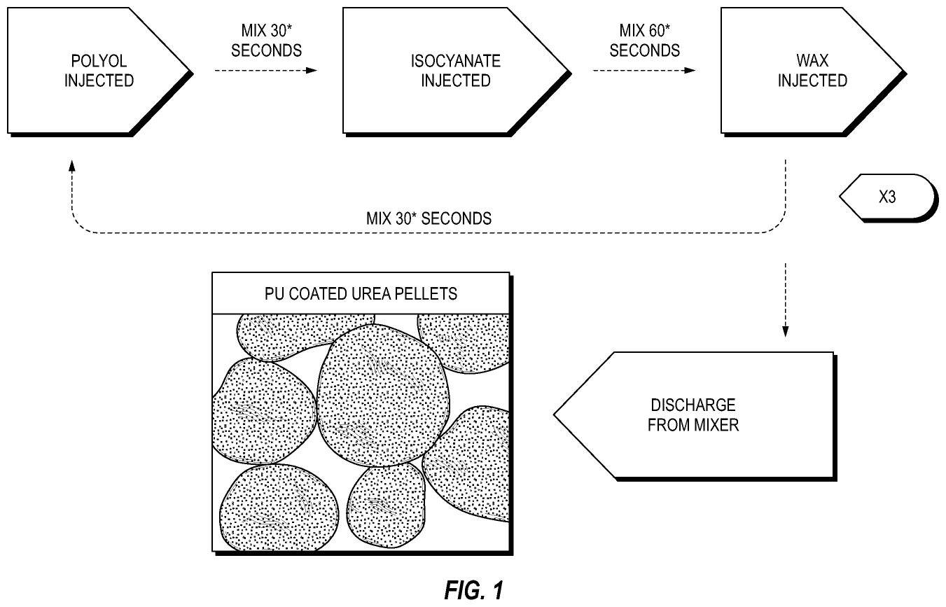

A general overview of the process for coating the Fertilizer with the polyurethane coating layers is shown in FIG. 1. 4000 grams of the Fertilizer were preheated to 160° F. in a high-intensity Eirich mixer under continuous agitation. At 160° F., the first polyurethane coating layer is applied on top of the Fertilizer by using 22.62 grams of Isocyanate and 14.05 grams of Polyol. The mixing time was kept around 30 seconds and the reaction time after adding the Isocyanate was kept at 1 minute thereby yield a polyurethane coating layer that encapsulated the Fertilizer. This coating step was followed by the addition of 15 grams of Wax to seal any microcracks in the polyurethane coating layer. The mixing time for the Wax was kept at 30 seconds. A second polyurethane coating layer was then applied over the first polyurethane coating layer. A second application of Wax was then applied over the second polyurethane coating layer using the same application parameters described above. A third polyurethane coating layer was then applied over the second polyurethane coating layer. No Wax was applied onto the third polyurethane coating layer. Finally, a fourth polyurethane coating layer was applied over the third polyurethane coating layer. Like the third polyurethane coating layer, no Wax was applied over the fourth polyurethane coating layer. After completion of the reaction, free flowing coated urea particles were drawn out from the mixer to cool to room temperature. The total batch time required for this four-layer process was 7 minutes.

### Example 2: Water Submersible Controlled Release Fertilizer Particle

The water submersible controlled release fertilizer particle was made by taking the polyurethane coated fertilizer particle of Example 1 and applying/post adding the additive and filler (i.e., the hydrophilic outer layer) onto the polyurethane coated fertilizer particle of Example 1:

| Material | Weight %* |
|---|---|
| Additive | 1.0% |
| Filler | 1.0% |
| Total Coating** | 4.23% |

*Based on final weight of coated particle including the hydrophillic outer layer.
**Does not include hydrophilic outer layer. Only includes all polyurethane coating layers and wax coating layer.

4176.57 grams of the coated urea particles from Example 1 were added to the high-intensity Eirich mixer at room temperature and agitation started. A charge of 40.0 grams of Additive was added and mixed for 20 seconds before the addition of 40.0 grams of Filler to the mixer. The materials could be mixed for an additional 60 seconds.

### Example 3: Water Submersible Controlled Release Fertilizer Particle

The water submersible controlled release fertilizer particle was made by taking the polyurethane coated fertilizer particle of Example 1 and applying/post adding the additive and filler (i.e., the hydrophilic outer layer) onto the polyurethane coated fertilizer particle of Example 1:

| Material | Weight %* |
|---|---|
| Additive | 1.0% |
| Filler | 1.0% |
| Total Coating** | 3.3% |

*Based on final weight of coated particle including the hydrophillic outer layer.
**Does not include hydrophilic outer layer. Only includes all polyurethane coating layers and wax coating layer.

4176.57 grams of the coated urea particles from Example 1 were added to the high-intensity Eirich mixer at room temperature and agitation started. A charge of 40.0 grams of Additive was added and mixed for 20 seconds before the addition of 40.0 grams of Filler to the mixer. The materials could be mixed for an additional 60 seconds.

### Description of the WATER IMMERSION TEST

The WATER IMMERSION TEST is used to simulate a simplistic “waterflood event”. The WATER IMMERSION TEST consists of the following steps: (i) adding 50 grams of water submersible controlled release fertilizer particles to a wide-open metal container (i.e., a 13.5 quart, full-size disposable aluminum pan having dimensions of 20 inches long, 13 inches wide, and 3 inches deep), which is lying flat on a solid flat surface, and spreading the water submersible controlled release fertilizer particles evenly over the bottom of the metal container; (ii) adding a flowing water stream, which is at room temperature, to one corner of the container; (iii) contacting the particles with the flowing water current.

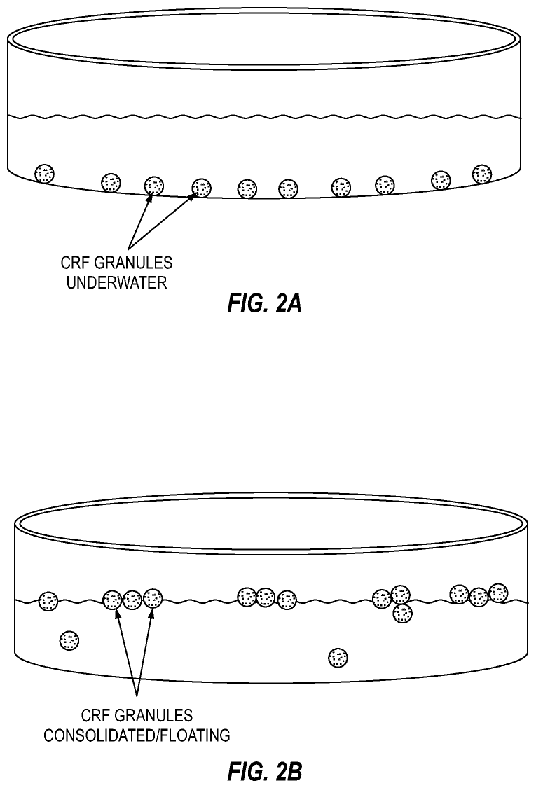

FIG. 2 depicts a result of a test conducted on a plurality of water submersible controlled release fertilizer particles after the particles were subjected to the WATER IMMERSION TEST versus a plurality of controlled release fertilizer particles that lack the hydrophilic outer layer (“Non-Coated CRF”). After the fertilizer particles were subjected to the WATER IMMERSION TEST, the orientation and position of the particles were visually observed. The water submersible controlled release fertilizer particles mimicked the depiction of FIG. 2a (i.e., particles are not consolidated/agglomerated and are at the bottom of the container) while the Non-Coated CRF mimicked the depiction of FIG. 2b (i.e., particles are consolidated/agglomerated and/or floating). In other words, the instant wetting or sinking characteristics of the water submersible controlled release fertilizer particles were superior when compared to controlled releases fertilizer particles that lack the hydrophilic outer layer.

### Nutrient Release Performance

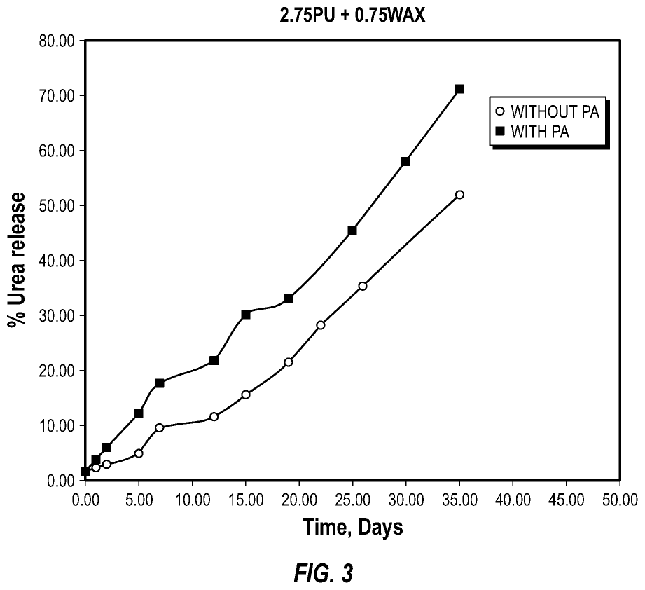

FIG. 3 depicts the percent urea release over a given time period. As can be seen in FIG. 3, the water submersible controlled release fertilizer particles performs similarly to the Non-Coated CRF when it comes to controlled urea release over serval days. However, unlike the Non-Coated CRF, the water submersible controlled release fertilizer also has the added benefit of staying submerged in the water environment. This is advantageous because it allows for the concentrated release of nutrients at the soil level where the plants are growing (i.e., where the roots are located) rather than being dispersed/diluted throughout the water environment.

1. A water submersible controlled release fertilizer particle comprising: (i) a fertilizer core material; (ii) a polyurethane coating layer encapsulating the fertilizer core material; and (iii) a hydrophilic outer layer encapsulating the polyurethane coating layer wherein the hydrophilic outer layer dissolves when subjected to water for a period ranging from 0 hours to 24 hours.

2. The water submersible controlled release fertilizer particle according to claim 1, wherein Component (iii) aids in the submersion of the controlled release fertilizer particle.

3. The water submersible controlled release fertilizer particle according to claim 1, wherein the fertilizer particle does not float in water.

4. The water submersible controlled release fertilizer particle according to claim 3, wherein the fertilizer particle remain at a surface bottom of a container when subjected to the WATER IMMERSION TEST.

5. The water submersible controlled release fertilizer particle according to claim 1, wherein Component (iii) comprises a polyol compound and an inorganic material.

6. The water submersible controlled release fertilizer particle according to claim 1, wherein Component (ii) is the reaction product of an isocyanate compound and an isocyanate reactive compound.

7. The water submersible controlled release fertilizer particle according to claim 6, wherein a wax layer encapsulates Component (ii).

8. The water submersible controlled release fertilizer particle according to claim 6, wherein a second polyurethane coating layer encapsulates Component (ii).

9. The water submersible controlled release fertilizer particle according to claim 8, wherein a third polyurethane coating layer encapsulates the second coating layer.

10. The water submersible controlled release fertilizer particle according to claim 9, wherein at least one of the second and third polyurethane coating layers do not contain a wax compound.

11. A method of making a water submersible controlled release fertilizer particle comprising: encapsulating a fertilizer core material with a polyurethane coating layer; and encapsulating the polyurethane coating layer with a hydrophilic outer layer that dissolves when subjected to water for a period ranging from 0 hours to 24 hours.

12. (canceled)

13. The method according to claim 11, wherein the fertilizer does not float in water.

14. The method according to claim 11, wherein the fertilizer particle remain at a bottom of a container when subjected to the WATER IMMERSION TEST.

15. The method according to claim 11, wherein the hydrophilic outer layer comprises a polyol compound and a calcium silicate material.

16. The method according to claim 11, wherein the polyurethane coating layer is the reaction product of an isocyanate compound and an isocyanate reactive compound.

17. The method according to claim 16, wherein the polyurethane coating layer further comprises a wax layer encapsulating Component (ii).

18. The method according to claim 16, wherein the method further comprises encapsulating the polyurethane coating layer with a second polyurethane coating layer.

19. The method according to claim 18, wherein the method further comprises encapsulating the second polyurethane coating layer with a third polyurethane coating layer.

20. (canceled)

21. A water submersible controlled release fertilizer particle comprising: (i) a fertilizer core material; (ii) a polyurethane coating layer encapsulating the fertilizer core material; and (iii) a hydrophilic outer layer encapsulating the polyurethane coating layer wherein the hydrophilic outer layer dissolves when subjected to water.

22. A method of making a water submersible controlled release fertilizer particle comprising: encapsulating a fertilizer core material with a polyurethane coating layer; and encapsulating the polyurethane coating layer with a hydrophilic outer layer that dissolves when subjected to water.
